(19) United States
(12) Patent Application Publication
(10) Pub. No.: US 2025/0306429 A1
(43) Pub. Date: Oct. 2, 2025

(54) METHOD OF MANUFACTURING WAVELENGTH CONVERSION ELEMENT, AND WAVELENGTH CONVERSION ELEMENT

(71) Applicant: NGK INSULATORS, LTD., Nagoya-shi (JP)

(72) Inventors: Shun HOSONO, Nagoya-shi (JP); Shoichiro YAMAGUCHI, Ichinomiya-shi (JP); Yuki NOMOTO, Nagoya-shi (JP)

(21) Appl. No.: 19/234,352

(22) Filed: Jun. 11, 2025

Related U.S. Application Data
(63) Continuation of application No. PCT/JP2023/037937, filed on Oct. 19, 2023.

(30) Foreign Application Priority Data
Dec. 23, 2022 (JP) 2022-207593

(51) Int. Cl. G02F 1/35; G02F 1/355

(52) U.S. Cl. CPC G02F 1/353; G02F 1/3509; G02F 1/355

(57) ABSTRACT

A method of manufacturing a wavelength conversion element including a periodic polarization inversion structure, includes: forming the periodic polarization inversion structure by alternately forming polarization inversion portions and non-polarization inversion portions on a ferroelectric substrate; etching a surface of the ferroelectric substrate provided with the periodic polarization inversion structure, to form level differences between the polarization inversion portions and the non-polarization inversion portions; forming a joining layer having a first thickness on the ferroelectric substrate provided with the level differences; polishing a surface of the joining layer to cause the joining layer to have a second thickness; and joining a support substrate to the polished surface of the joining layer.

### CROSS-REFERENCE TO RELATED APPLICATION

This application is a continuation application of PCT/JP2023/037937, filed on Oct. 19, 2023, which claims the benefit of priority of Japanese Patent Application No. JP2022-207593, filed on Dec. 23, 2022, the entire contents of which are incorporated herein by reference.

### 1. Technical Field

The present invention relates to a wavelength conversion element including a periodic polarization inversion structure, and a method of manufacturing the wavelength conversion element.

### 2. Description of Related Art

Conventionally, as a light source realizing a laser of, for example, blue light or green light, a light source having a structure in which a laser oscillating red light as a fundamental wave is combined with a wavelength conversion element functioning as a second-harmonic generation element is known. In the wavelength conversion element used in such a light source, wavelength conversion is performed by a QPM (Quasi-Phase Matching) structure that is realized using a periodic polarization inversion structure in which polarization inversion portions and non-polarization inversion portions are periodically alternately formed.

Patent Literature 1 (Japanese Patent No. 4100937) discloses a wavelength conversion element in which, in a periodic polarization inversion structure formed in an optical waveguide, first polarization inversion portions and second polarization inversion portions different in design widths are alternately arranged, a difference between design widths of the first polarization inversion portions and design widths of the second polarization inversion portions is an odd multiple of the accuracy of the mask used for forming an electrode, and the design widths of the non-polarization inversion portions are substantially fixed.

In a step of manufacturing the wavelength conversion element as disclosed in Patent Literature 1, a substrate surface is etched, and formation of periodic level differences in the polarization inversion portions is observed to confirm accurate formation of the periodic polarization inversion structure on the substrate in some cases. However, when a joining layer made of SiO2 or the like is formed for joining to a support substrate, on the substrate in which formation of the periodic polarization inversion structure has been confirmed in the above-described manner, the joining layer is formed on the level differences formed by the etching. Thus, similar level differences are also generated on a surface of the joining layer. When the substrate is joined to the support substrate through the joining layer to fabricate the wavelength conversion element in such a state, gaps caused by the level differences on the surface of the joining layer are formed between the joining layer and the support substrate. If air bubbles are caught in the gaps, the air bubbles are enclosed inside the wavelength conversion element, which may cause an appearance failure and the like.

The present invention is made in consideration of the above-described circumstances, and a main object of the present invention is to realize a wavelength conversion element that can prevent air bubbles from being enclosed inside the wavelength conversion element even when formation of the periodic polarization inversion structure by etching is confirmed, and a method of manufacturing the wavelength conversion element.

### SUMMARY OF THE INVENTION

A method of manufacturing a wavelength conversion element according to the present invention is a method of manufacturing a wavelength conversion element including a periodic polarization inversion structure, and the method includes: forming the periodic polarization inversion structure by alternately forming polarization inversion portions and non-polarization inversion portions on a ferroelectric substrate; etching a surface of the ferroelectric substrate provided with the periodic polarization inversion structure, to form level differences between the polarization inversion portions and the non-polarization inversion portions; forming a joining layer having a first thickness on the ferroelectric substrate provided with the level differences; polishing a surface of the joining layer to cause the joining layer to have a second thickness; and joining a support substrate to the polished surface of the joining layer.

A wavelength conversion element according to the present invention includes a periodic polarization inversion structure, and includes: the periodic polarization inversion structure in which polarization inversion portions and non-polarization inversion portions are alternately provided on a ferroelectric substrate and level differences are provided between the polarization inversion portions and the non-polarization inversion portions; a joining layer provided on the ferroelectric substrate including the level differences; and a support substrate joined onto the joining layer. The level differences each have a height of 10 nm to 40 nm. Unevenness on the surface of the joining layer on the support substrate side is 2 nm or less.

According to the present invention, it is possible to realize a wavelength conversion element that can prevent air bubbles from being enclosed inside a wavelength conversion element even when formation of the periodic polarization inversion structure by etching is confirmed, and a method of manufacturing the wavelength conversion element.

### BRIEF DESCRIPTION OF THE DRAWINGS

FIG. 1 is a schematic cross-sectional view illustrating an outline configuration of a wavelength conversion element according to an embodiment of the present invention.

FIG. 2A is a diagram illustrating a step of forming a periodic polarization inversion structure, among steps of manufacturing a wavelength conversion element according to a comparative example.

FIG. 2B is a diagram illustrating a step of performing etching, among the steps of manufacturing the wavelength conversion element according to the comparative example.

FIG. 2C is a diagram illustrating a step of forming a joining layer, among the steps of manufacturing the wavelength conversion element according to the comparative example.

FIG. 2D is a diagram illustrating a step of joining a support substrate, among the steps of manufacturing the wavelength conversion element according to the comparative example.

FIG. 3A is a diagram illustrating a step of forming a periodic polarization inversion structure, among steps of manufacturing the wavelength conversion element according to the embodiment of the present invention.

FIG. 3B is a diagram illustrating a step of performing etching, among the steps of manufacturing the wavelength conversion element according to the embodiment of the present invention.

FIG. 3C is a diagram illustrating a step of forming a joining layer, among the steps of manufacturing the wavelength conversion element according to the embodiment of the present invention.

FIG. 3D is a diagram illustrating a step of polishing the joining layer, among the steps of manufacturing the wavelength conversion element according to the embodiment of the present invention.

FIG. 3E is a diagram illustrating a step of joining a support substrate, among the steps of manufacturing the wavelength conversion element according to the embodiment of the present invention.

FIGS. 4A, 4B and 4C are diagrams illustrating observation results of a surface of the joining layer before, during, and after the polishing step respectively.

FIG. 5A illustrates an image of the joining layer of the wavelength conversion element according to the comparative example, observed by a dark-field microscope.

FIG. 5B illustrates an image of the joining layer of the wavelength conversion element according to the embodiment of the present invention, observed by the dark-field microscope.

### DESCRIPTION OF PREFERRED EMBODIMENTS

An embodiment of the present invention is described below with reference to drawings, but the present invention is not limited to the embodiment. To make description clear, a width, a thickness, a shape, and the like of each component illustrated in the drawings may be schematically illustrated as compared with components in the embodiment. However, the schematic illustration of the components is merely illustrative, and does not limit interpretation of the present invention.

### Structure of Wavelength Conversion Element

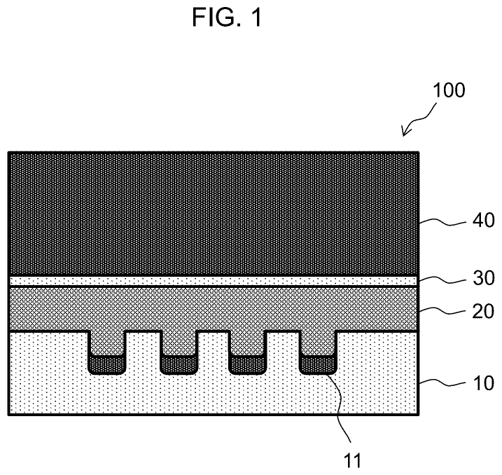

FIG. 1 is a schematic cross-sectional view illustrating an outline configuration of a wavelength conversion element according to an embodiment of the present invention. A wavelength conversion element 100 has a structure in which a ferroelectric substrate 10 is joined to a support substrate 40 through a joining layer 20 and an adhesive layer 30.

The ferroelectric substrate 10 is a substrate configured using a ferroelectric substance. As the ferroelectric substance configuring the ferroelectric substrate 10, for example, MgO:LN (MgO-doped lithium niobate) or MgO:LT (MgO-doped lithium tantalate) may be used. Polarization inversion portions 11 that are formed to have a polarization direction opposite to the other portions are periodically disposed at predetermined intervals on the ferroelectric substrate 10. In other words, the polarization inversion portions 11 and other portions (non-polarization inversion portions) are periodically alternately provided on the ferroelectric substrate 10. This forms a periodic polarization inversion structure on the ferroelectric substrate 10.

The joining layer 20 is used to form a joining surface for joining the ferroelectric substrate 10 to the support substrate 40. In a case where the ferroelectric substrate 10 is joined to the support substrate 40 through the joining layer 20, the joining surface suitable for joining is formed on the joining layer 20, and the ferroelectric substrate 10 can be firmly joined to the support substrate 40. Further, the periodic polarization inversion structure provided on the ferroelectric substrate 10 is not directly joined to the support substrate 40, and can be joined to the support substrate 40 through the joining layer 20. This makes it possible to protect the periodic polarization inversion structure.

The joining layer 20 is configured using, for example, an amorphous body of SiO2. When the joining layer 20 is made of the amorphous body, for example, polishing described below is easily performable, and a surface roughness suitable for the joining surface is easily obtainable.

The joining layer 20 can be formed by an optional appropriate method. The joining layer 20 can be formed by, for example, physical vapor deposition such as sputtering, vacuum deposition, and ion-assisted deposition (IAD), chemical vapor deposition, or atomic layer deposition (ALD). Formation of the joining layer 20 can be performed, for example, at a room temperature (25° C.) to 300° C.

The adhesive layer 30 joins the ferroelectric substrate 10 to the support substrate 40 through the joining layer 20. The adhesive layer 30 is made of, for example, a resin, and interposes between the joining layer 20 and the support substrate 40 to bond the joining layer 20 and the support substrate 40 together. In other words, in the wavelength conversion element 100, a surface of the joining layer 20 and the support substrate 40 are joined through the adhesive layer 30.

The support substrate 40 supports the ferroelectric substrate 10. An optional appropriate substrate can be used as the support substrate 40. The support substrate 40 may be made of a single crystal body or a polycrystal body. The support substrate 40 may be made of a metal. The material configuring the support substrate 40 is preferably selected from a group consisting of silicon, sialon, sapphire, cordierite, mullite, glass, quartz, crystal, alumina, SUS, an iron-nickel alloy (42 alloy), LN (LiNbO3: lithium niobate), LT (LiTaO3: lithium tantalate), and brass. As a thickness of the support substrate 40, an optional appropriate thickness can be adopted.

The silicon may be single crystal silicon, polycrystal silicon, or high-resistance silicon. The support substrate 40 may be an SOI (Silicon on Insulator).

Typically, the sialon is a ceramic obtained by sintering a mixture of silicon nitride and alumina, and has a composition represented by, for example, Si6-wAlwOwN8-w. More specifically, the sialon has a composition in which alumina is mixed into silicon nitride. In the formula, w indicates a mixing ratio of alumina, and is preferably 0.5 or more and 4.0 or less.

Typically, the sapphire is a single crystal body having a composition of Al2O3, and the alumina is a polycrystal body having a composition of Al2O3. The alumina is preferably translucent alumina.

Typically, the cordierite is a ceramic having a composition of 2MgO·2Al2O3·5SiO2, and the mullite is a ceramic having a composition within a range from 3Al2O3·2SiO2 to 2Al2O3·SiO2

The wavelength conversion element 100 described above is used as, for example, a second-harmonic generation element that performs wavelength conversion on a red laser beam to obtain a blue or green laser beam. Although not illustrated, the wavelength conversion element 100 may further include an optional layer. Types and functions, the number, combination, arrangement, and the like of layers can be appropriately set depending on a purpose.

The wavelength conversion element 100 can be manufactured in an optional appropriate shape. Further, a size of the wavelength conversion element 100 can be appropriately set depending on a purpose.

### Manufacturing Method According to Comparative Example

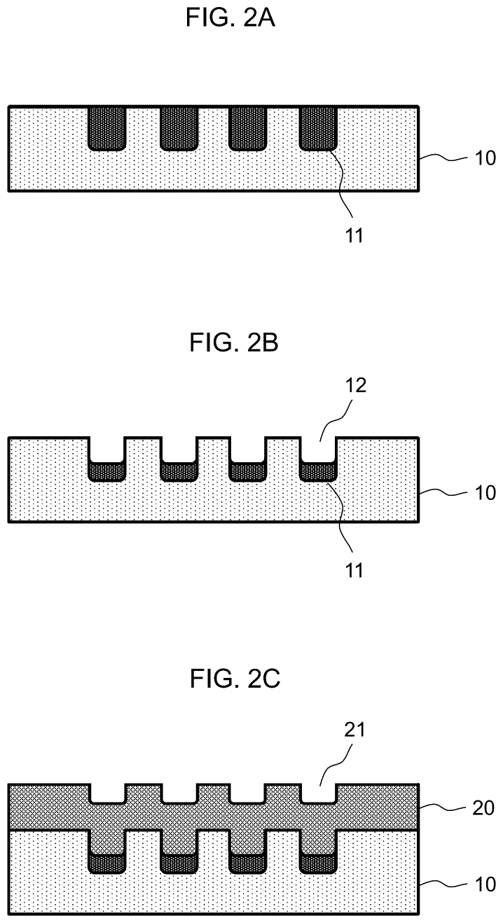

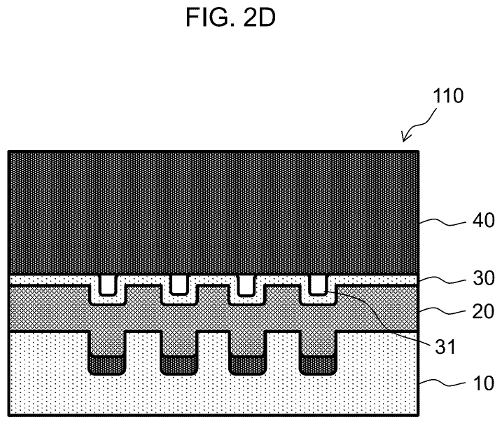

Before a method of manufacturing the above-described wavelength conversion element 100 is described, a method of manufacturing a wavelength conversion element according to a comparative example in a case where the present invention is not applied is described below with reference to FIGS. 2A to 2D.

FIG. 2A is a diagram illustrating a step of forming a periodic polarization inversion structure, among steps of manufacturing a wavelength conversion element 110 according to the comparative example. In this step, a predetermined voltage is applied to each of the polarization inversion portions 11 and the other portions of the ferroelectric substrate 10 made of MgO:LN or MgO:LT, to periodically alternately form the polarization inversion portions 11 and non-polarization inversion portions. This forms the periodic polarization inversion structure on the ferroelectric substrate 10.

FIG. 2B is a diagram illustrating a step of performing etching, among the steps of manufacturing the wavelength conversion element 110 according to the comparative example. In this step, etching is performed by applying mixed liquid of hydrofluoric acid and nitric acid to a surface of the ferroelectric substrate 10 in which the periodic polarization inversion structure has been formed in the manufacturing step illustrated in FIG. 2A. At this time, an etching rate of the polarization inversion portions 11 and an etching rate of the non-polarization inversion portions are different from each other. Therefore, the polarization inversion portions 11 are more deeply eroded as compared with the non-polarization inversion portions, and level differences 12 are formed between the polarization inversion portions 11 and the non-polarization inversion portions on the surface of the ferroelectric substrate 10. By observing the level differences 12, formation of the periodic polarization inversion structure on the ferroelectric substrate 10 can be confirmed.

FIG. 2C is a diagram illustrating a step of forming a joining layer, among the steps of manufacturing the wavelength conversion element 110 according to the comparative example. In this step, the joining layer 20 is formed by forming a film of an amorphous body of SiO2 or the like on the ferroelectric substrate 10 in which the level differences 12 have been formed in the etching step illustrated in FIG. 2B. In the forming step, as described above, the joining layer 20 can be formed by using various film formation methods such that a thickness of the joining layer 20 from the surface of the ferroelectric substrate 10 becomes a predetermined thickness corresponding to a film forming time. Therefore, level differences 21 corresponding to the respective level differences 12 on the surface of the ferroelectric substrate 10 are formed on a surface of the joining layer 20.

FIG. 2D is a diagram illustrating a step of joining a support substrate, among the steps of manufacturing the wavelength conversion element 110 according to the comparative example. In this step, the adhesive layer 30 is formed by applying a resin or the like to the surface of the joining layer 20 formed in the forming step illustrated in FIG. 2C, and the support substrate 40 is placed on the adhesive layer 30. As a result, the joining layer 20 and the support substrate 40 are bonded with the adhesive layer 30, and the ferroelectric substrate 10 and the support substrate 40 are joined through the joining layer 20 and the adhesive layer 30.

By performing the steps illustrated in FIGS. 2A to 2D described above in order, the wavelength conversion element 110 according to the comparative example is manufactured.

In the wavelength conversion element 110 according to the above-described comparative example, gaps 31 are formed between the adhesive layer 30 and the support substrate 40 as illustrated in FIG. 2D. The gaps 31 are formed due to the fact that, in the joining step illustrated in FIG. 2D, the adhesive layer 30 is formed along the level differences 21 present on the surface of the joining layer 20, and the joining layer 20 and the support substrate 40 are joined through the adhesive layer 30 in this state. In other words, in the method of manufacturing the wavelength conversion element according to the comparative example described with reference to FIGS. 2A to 2D, the level differences 12 are formed on the surface of the ferroelectric substrate 10 in the etching step illustrated in FIG. 2B, and the level differences 21 corresponding to the respective level differences 12 are formed on the surface of the joining layer 20 formed in the subsequent forming step illustrated in FIG. 2C, which results in formation of the gaps 31 between the adhesive layer 30 and the support substrate 40. If air bubbles are caught in the gaps 31 in the joining step illustrated in FIG. 2D, the wavelength conversion element 110 is fabricated in a state where the air bubbles are enclosed inside the wavelength conversion element 110.

The wavelength conversion element 110 is required to allow a laser beam to be subjected to wavelength conversion to pass therethrough. Thus, at least a part of the wavelength conversion element 110 is made of a transparent material. The air bubbles enclosed inside the wavelength conversion element 110 are visually recognizable from outside through the transparent portion, which may cause appearance failure. In addition, expansion, contraction, and the like of the air bubbles with temperature change may lead to a defect such as joining failure. In other words, in the wavelength conversion element 110 according to the comparative example, these issues may occur because the gaps 31 are formed between the adhesive layer 30 and the support substrate 40.

### Manufacturing Method According to Present Invention

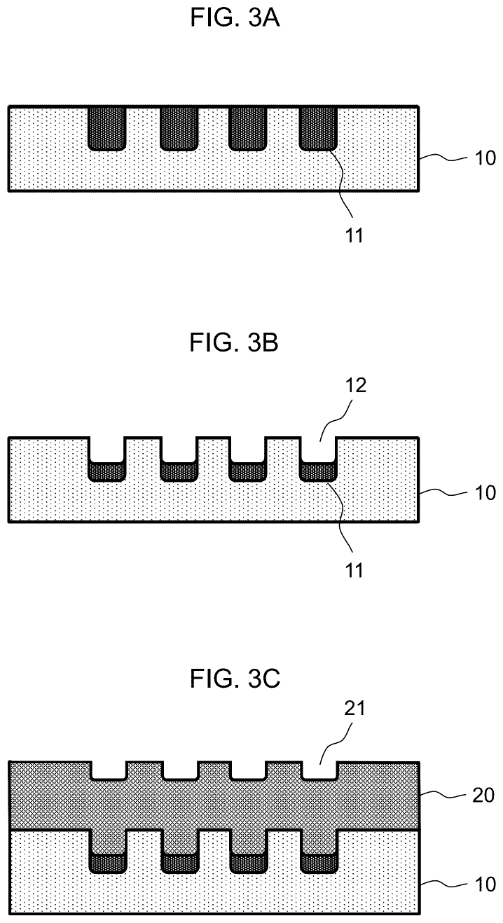

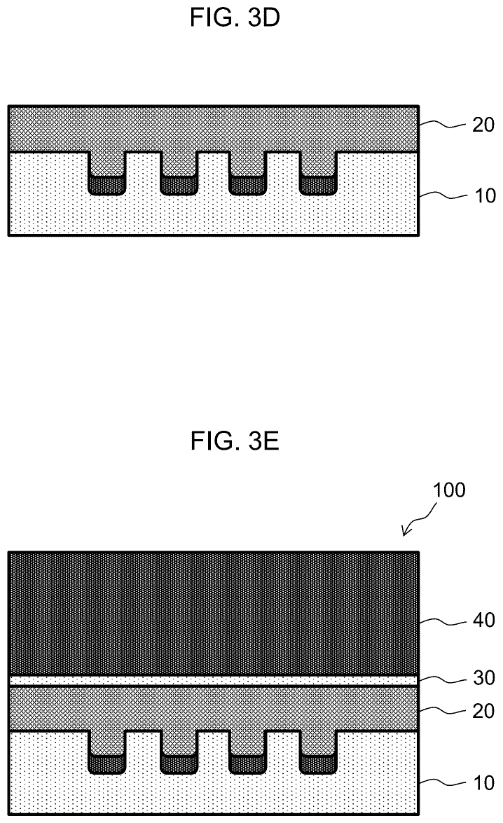

In the following, the method of manufacturing the wavelength conversion element according to the present invention for solving the issues in the above-described comparative example is described with reference to FIGS. 3A to 3E.

FIG. 3A is a diagram illustrating a step of forming the periodic polarization inversion structure, among steps of manufacturing the wavelength conversion element 100 according to the embodiment of the present invention. In this step, by a method similar to the method in the step of forming the periodic polarization inversion structure according to the comparative example described with reference to FIG. 2A, the periodic polarization inversion structure is formed on the ferroelectric substrate 10 by periodically alternately forming the polarization inversion portions 11 and the non-polarization inversion portions on the ferroelectric substrate 10.

FIG. 3B is a diagram illustrating a step of performing etching, among the steps of manufacturing the wavelength conversion element 100 according to the embodiment of the present invention. In this step, in a manner similar to the etching step according to the comparative example described with reference to FIG. 2B, the level differences 12 are formed between the polarization inversion portions 11 and the non-polarization inversion portions by performing etching on the surface of the ferroelectric substrate 10 in which the periodic polarization inversion structure has been formed in the manufacturing step illustrated in FIG. 3A. A height of each of the level differences 12 is, for example, 10 nm to 40 nm.

FIG. 3C is a diagram illustrating a step of forming the joining layer, among the steps of manufacturing the wavelength conversion element 100 according to the embodiment of the present invention. In this step, in a manner similar to the etching step according to the comparative example described with reference to FIG. 2C, the joining layer 20 is formed on the ferroelectric substrate 10 in which the level differences 12 have been formed in the etching step illustrated in FIG. 3B. At this time, to sufficiently secure the thickness of the joining layer 20 even after the joining layer 20 is polished in a polishing step described below, the thickness of the joining layer 20 is preferably made large (first thickness) as compared with the etching step according to the comparative example. Note that, as in the comparative example, the level differences 21 corresponding to the respective level differences 12 on the surface of the ferroelectric substrate 10 are formed on the surface of the joining layer 20. The first thickness is, for example, 480 nm to 700 nm.

FIG. 3D is a diagram illustrating a step of polishing the joining layer, among the steps of manufacturing the wavelength conversion element 100 according to the embodiment of the present invention. In this step, processing such as grinding and polishing is performed on the joining layer 20 formed in the forming step illustrated in FIG. 3C, until the thickness of the joining layer 20 becomes a predetermined thickness (second thickness). As a result, the level differences 21 present on the surface of the joining layer 20 at an end timing of the forming step illustrated in FIG. 3C are eliminated, and a flat surface is formed such that, for example, unevenness on the surface (surface on side joined to support substrate 40) of the joining layer 20 becomes 2 nm or less. At this time, a thickness difference (difference between the first thickness and the second thickness) of the joining layer 20 before and after the polishing can be made to be, for example, 5times or more and 15 times or less, more preferably 5times or more and 10 times or less the height of each of the level differences 12 (level differences 21). When the thickness difference is within the range, it is possible to sufficiently planarize the surface of the joining layer 20 while maintaining a necessary thickness of the joining layer 20 after the polishing. The second thickness is, for example, 380 nm to 500 nm.

FIG. 3E is a diagram illustrating a step of joining the support substrate, among the steps of manufacturing the wavelength conversion element 100 according to the embodiment of the present invention. In this step, the adhesive layer 30 is formed by applying a resin or the like to the surface of the joining layer 20 polished in the polishing step illustrated in FIG. 2D, in a manner similar to the joining step according to the comparative example described with reference to FIG. 2D, and the support substrate 40 is placed on the adhesive layer 30. As a result, the joining layer 20 and the support substrate 40 are bonded with the adhesive layer 30, and the ferroelectric substrate 10 and the support substrate 40 are joined through the joining layer 20 and the adhesive layer 30.

By performing the steps illustrated in FIGS. 3A to 3E described above in order, the wavelength conversion element 100 according to the present embodiment is manufactured.

In the wavelength conversion element 100 according to the present embodiment, the issues occurring on the wavelength conversion element 110 according to the above-described comparative example can be eliminated. More specifically, since the level differences 21 are removed from the surface of the joining layer 20 in the polishing step illustrated in FIG. 3D, the gaps 31 as illustrated in FIG. 2D are not formed between the adhesive layer 30 and the support substrate 40 when the adhesive layer 30 is formed in the subsequent joining step illustrated in FIG. 3E. This makes it possible to prevent air bubbles from being enclosed inside the wavelength conversion element 100, and to avoid occurrence of a defect such as appearance failure and joining failure caused by the air bubbles.

In the above-described joining step, the surfaces of the joining layer 20 and the support substrate 40 are preferably washed, for example, in order to remove residues of a polishing agent. Examples of a washing method include wet washing, dry washing, and scrub washing. Among them, the scrub washing is preferable because washing can be easily and efficiently performed. Specific examples of the scrub washing include a method in which a scrub washing machine performs washing using a detergent (for example, SUNWASH series manufactured by Lion Corporation), and then using a solvent (for example, mixed solution of acetone and isopropyl alcohol (IPA)).

### EXAMPLE

In the following, Example of the method of manufacturing the wavelength conversion element 100 according to the present invention is described. The following procedures were performed at a room temperature unless otherwise noted.

The ferroelectric substrate 10 was prepared by using, as a material, MgO:LN that was made of lithium niobate single crystal doped with 5% of magnesium and had a diameter of 4 inches and a thickness of 0.3 mm. A plurality of electrodes were installed at predetermined intervals on the ferroelectric substrate 10, and were coupled to a power source. A pulsed voltage of 1.4 kV (pulse width is 20 msec, 25 hertz, number of pulses is four, and upper limit of applied current is 2 mA) was generated from the power source. In this manner, the step of forming the periodic polarization inversion structure illustrated in FIG. 3A was performed to form the periodic polarization inversion structure.

Thereafter, the etching step illustrated in FIG. 3B was performed by etching the surface of the ferroelectric substrate 10 by using mixed liquid of hydrofluoric acid (aqueous solution of hydrogen fluoride) and nitric acid, to form the level differences 12 between the polarization inversion portions 11 and the non- polarization inversion portions. Note that the etching step illustrated in FIG. 3B may be performed by using an aqueous solution in which concentration of hydrogen fluoride was 50 wt, in place of the mixed liquid of hydrofluoric acid and nitric acid.

Thereafter, the forming step illustrated in FIG. 3C was performed by forming, by sputtering, an SiO2 film having a thickness of 540 nm on the surface of the ferroelectric substrate 10 including the level differences 12, to form the joining layer 20 on the ferroelectric substrate 10. A predetermined range on the surface of the joining layer 20 was observed by an atomic force microscope (AFM) to confirm formation of the level differences 21.

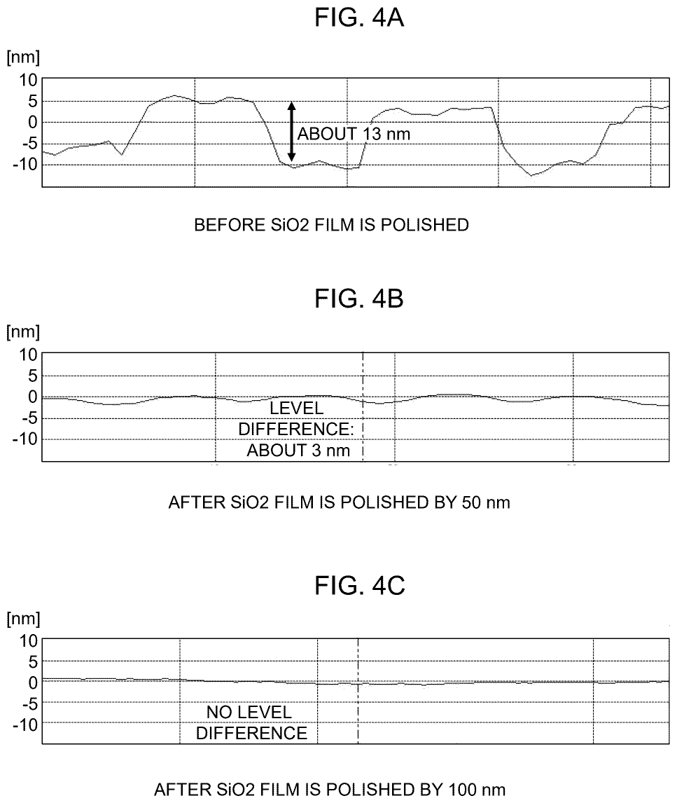

FIG. 4A is a diagram illustrating an observation result of the surface of the joining layer 20 after the forming step (before the polishing step is performed). In this state, it could be confirmed that the level differences 21 each having a height of about 13 nm were formed on the surface of the joining layer 20.

Thereafter, the polishing step illustrated in FIG. 3D was performed by polishing the surface of the joining layer 20 by chemical mechanical polishing (CMP). In the polishing step, the surface of the joining layer 20 was polished by about 100 nm until the thickness of the joining layer 20 was reduced from 540 nm to 440 nm, and the surface of the joining layer 20 was uniformized. The predetermined range on the surface of the joining layer 20 at this time was observed by the atomic force microscope (AFM) to confirm that the level differences 21 were removed and the surface of the joining layer 20 was flat.

FIG. 4B is a diagram illustrating an observation result of the surface of the joining layer 20 during the polishing step. FIG. 4B illustrates the observation result in a state where the surface of the joining layer 20 is polished by 50 nm. In this state, it could be confirmed that the height of each of the level differences 21 was reduced to about 3 nm, but the level differences 21 were not completely removed.

FIG. 4C is a diagram illustrating an observation result of the surface of the joining layer 20 after the polishing step. FIG. 4C illustrates the observation result in a state where the surface of the joining layer 20 is polished by 100 nm. In this state, it could be confirmed that the level differences 21 substantially completely disappeared (2 nm or less), and the surface of the joining layer 20 was flat.

Finally, the joining step illustrated in FIG. 3E was performed by applying a resin (for example, epoxy resin) to the surface of the joining layer 20 after polished by 100 nm, to form the adhesive layer 30, placing the support substrate 40 on the adhesive layer 30, and drying the adhesive layer 30. As a result, the wavelength conversion element 100 having the structure illustrated in FIG. 1 was obtained.

### Observation of Air Bubbles

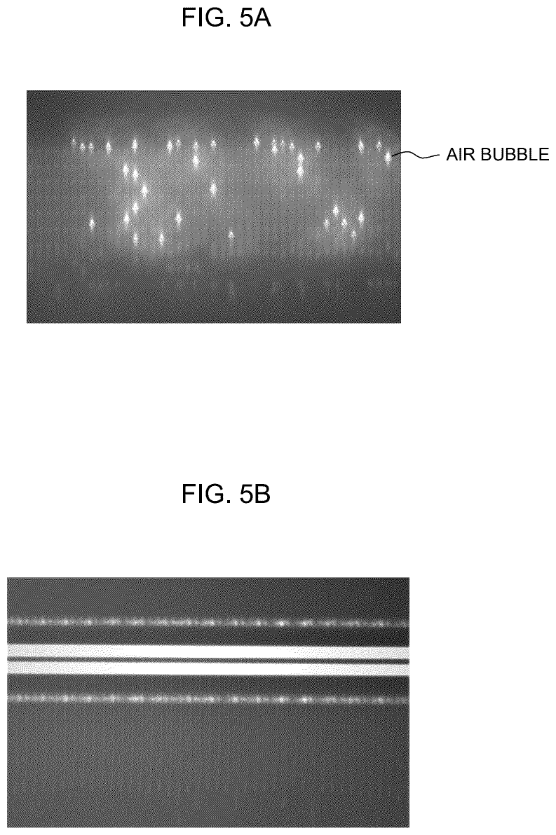

The wavelength conversion element 110 according to the above-described comparative example and the wavelength conversion element 100 according to the present embodiment fabricated in the above-described manner were observed from the ferroelectric substrate 10 side by a dark-field microscope. FIGS. 5A and 5B illustrate observation images thereof.

In an observation image illustrated in FIG. 5A, air bubbles enclosed inside the wavelength conversion element 110 appear brighter than the other portions. Therefore, it can be known that a large number of air bubbles are enclosed inside the wavelength conversion element 110. On the other hand, in an observation image illustrated in FIG. 5B, it can be known that no air bubble is present inside the wavelength conversion element 100, and enclosure of air bubbles can be suppressed.

According to the embodiment of the present invention described above, the following functional effects are achieved.
(1) A method of manufacturing the wavelength conversion element 100 including the periodic polarization inversion structure includes: forming the periodic polarization inversion structure by alternately forming the polarization inversion portions 11 and the non-polarization inversion portions on the ferroelectric substrate 10 (FIG. 3A: the step of forming periodic polarization inversion structure); etching the surface of the ferroelectric substrate 10 provided with the periodic polarization inversion structure, to form the level differences 12 between the polarization inversion portions 11 and the non-polarization inversion portions (FIG. 3B: the step of performing etching); forming the joining layer 20 having the first thickness on the ferroelectric substrate 10 provided with the level differences 12 (FIG. 3C: the step of forming joining layer); polishing the surface of the joining layer 20 to cause the joining layer 20 to have the second thickness (FIG. 3D: the step of polishing joining layer); and joining the support substrate 40 to the polished surface of the joining layer 20 (FIG. 3E: the step of joining support substrate). This makes it possible to realize the method of manufacturing the wavelength conversion element that can prevent air bubbles from being enclosed inside the wavelength conversion element even when the formation of the periodic polarization inversion structure by etching is confirmed.
(2) The difference between the first thickness and the second thickness of the joining layer 20 is preferably 5 times or more and 15 times or less the height of each of the level differences 12. This makes it possible to sufficiently planarize the surface of the joining layer 20 while maintaining the thickness of the joining layer 20 after the polishing.
(3) In the step of joining the support substrate, the surface of the joining layer 20 and the support substrate 40 are joined through the adhesive layer 30.

The adhesive layer 30 is made of, for example, a resin. This makes it possible to easily and firmly join the surface of the joining layer 20 and the support substrate 40.
(4) The ferroelectric substrate 10 can be made of any of MgO:LN and MgO:LT. This makes it possible to configure the ferroelectric substrate 10 by an optional material depending on an application.

The present invention is not limited to the above-described embodiment, and can be implemented using an optional component without departing from the spirit of the present invention.

The above-described embodiment and modification are merely illustrative, and the present invention is not limited to the contents of the above-described embodiment and modification as long as the features of the invention are not impaired. Although various embodiment and modification are described above, the present invention is not limited to the contents of the embodiment and modification. Other aspects considered to be within the scope of the technical idea of the present invention are also included in the scope of the present invention.

What is claimed is:

1. A method of manufacturing a wavelength conversion element including a periodic polarization inversion structure, the method comprising:
forming the periodic polarization inversion structure by alternately forming polarization inversion portions and non-polarization inversion portions on a ferroelectric substrate;
etching a surface of the ferroelectric substrate provided with the periodic polarization inversion structure, to form level differences between the polarization inversion portions and the non-polarization inversion portions;
forming a joining layer having a first thickness on the ferroelectric substrate provided with the level differences;
polishing a surface of the joining layer to cause the joining layer to have a second thickness; and
joining a support substrate to the polished surface of the joining layer.

2. The method of manufacturing the wavelength conversion element according to claim 1, wherein a difference between the first thickness and the second thickness is 5 times or more and 15 times or less a height of each of the level differences.

3. The method of manufacturing the wavelength conversion element according to claim 1, wherein the surface of the joining layer and the support substrate are joined through an adhesive layer.

4. The method of manufacturing the wavelength conversion element according to claim 3, wherein the adhesive layer is made of a resin.

5. The method of manufacturing the wavelength conversion element according to claim 1, wherein the ferroelectric substrate is made of any of MgO:LN and MgO:LT.

6. A wavelength conversion element including a periodic polarization inversion structure, the wavelength conversion element comprising:
the periodic polarization inversion structure in which polarization inversion portions and non-polarization inversion portions are alternately provided on a ferroelectric substrate and level differences are provided between the polarization inversion portions and the non-polarization inversion portions;
a joining layer provided on the ferroelectric substrate including the level differences; and
a support substrate joined onto the joining layer, wherein
the level differences each have a height of 10 nm to 40 nm, and
unevenness on the surface of the joining layer on the support substrate side is 2 nm or less.

7. The wavelength conversion element according to claim 6, further comprising an adhesive layer configured to join the joining layer and the support substrate.

8. The wavelength conversion element according to claim 7, wherein the adhesive layer is made of a resin.

9. The wavelength conversion element according to claim 6, wherein the ferroelectric substrate is made of any of MgO:LN and MgO:LT.

10. The wavelength conversion element according to claim 6, wherein the joining layer is made of an amorphous body of SiO2.
